(19) United States
(12) Patent Application Publication
(10) Pub. No.: US 2011/0276514 A1
(43) Pub. Date: Nov. 10, 2011

(54) EVALUATING THE QUALITY AND RISK-ROBUSTNESS OF AN ENERGY GENERATION CAPACITY RESOURCE PLAN UNDER INHERENT UNCERTAINTIES IN ENERGY MARKETS AND CARBON REGULATORY REGIME

(75) Inventors: Jayant R. Kalagnanam, Tarrytown, NY (US); Stuart A. Siegel, Millburn, NJ (US); Dharmashankar Subramanian, Stamford, CT (US)

(73) Assignee: INTERNATIONAL BUSINESS MACHINES CORPORATION, Armonk, NY (US)

(21) Appl. No.: 12/773,223

(22) Filed: May 4, 2010

(51) Int. Cl. G06Q 10/00; G06Q 50/00; G06N 5/02

(52) U.S. Cl. 705/348; 706/52

(57) ABSTRACT

The present invention includes a computing system for evaluating a quality and risk-robustness of a utility company's capacity resource plan (CRP). The computing system computes a net present value of a total cost distribution of the CRP. The computing system calculates a standardized risk measure defined over the net present value. The computing system computes a resource plan that minimizes the standardized risk measure. Then, the computing system compares the standardized risk measure and the resource plan.

### BACKGROUND

The present invention generally relates to evaluating a quality and risk-robustness of a utility company's capacity resource plan (CRP). More particularly, the present invention is related to quantifying a quality of the CRP.

Banks, insurance companies and credit rating agencies in Financial Industries and public utility regulators need to evaluate risk-robustness of a utility company's Capacity Resource Plan (CRP). It is advantageous that such an evaluation is performed with uncertainties in energy markets, fuel costs, and regulatory regimes for carbon and other pollutants and uncertainties in cost and performance of abatement options. Abatement refers to a reduction of Carbon Dioxide emissions that are generated in a process of Energy Production.

An abatement option is one of several ways in which the utility company may try to achieve a net reduction in CO₂ emissions. Examples of an abatement option include, without limitation, retrofits on existing generating units to improve efficiency (in order to produce the same amount of electric energy for lesser fuel usage, and hence lesser CO₂ emissions) and Carbon Capture and Sequestration technology (i.e., a technique for capturing carbon dioxide from its major sources and storing it away from atmosphere). The abatement option may also include a land contract that specifies land usage mode (e.g., how the land is going to be used until a specific time or how the land is going to be used without a limitation of the specific time.)

The CRP describes, without limitation, how much capacity (e.g., Mega Watts of a generation capacity) a utility company (e.g., Consolidated Edison, Inc.) will invest in terms of a capacity expansion in order to meet a growing demand, at what point in time the investment will be made, in what generating fuel type the capacity investment will be made (i.e., whether the capacity investment be made in nuclear, coal, gas, hydro, renewable resource, etc.), any other capital investments vis-à-vis efficiency improvement, carbon abatement and a new capacity addition.

Traditional solutions involve manual processes where utility companies publish their capacity resource plan (CRP), and interested parties (e.g., banks) manually review these plans to assess the quality and risk-robustness of the CRP. Further, there are no standards prescribing analytic techniques (i.e., techniques for evaluating the CRP), a choice of risk measures, and input assumptions (i.e., techniques and/or assumptions that are necessary for quantitatively characterizing and analyzing the uncertainties and risk inherent in any capacity resource plan) for performing the review. Such a manual process is labor-intensive and leads to an information management problem because the interested parties may evaluate many such resource plans.

A measure refers to an operation to select a number to represent a distribution. A metric refers to an interpretation of the selected number. There are a plurality of metrics of risks such as volatility, duration, convexity, etc. A measure upholding the risk metric is called a risk measure. Value-at-risk is an example of the risk measure and describes a probabilistic market risk (i.e., an exposure to the uncertainties) of a trading portfolio (e.g., fuel costs). Simon Benninga, et al., “Value-at-Risk (VaR)”, Mathematica in Education and Research, vol. 7, no. 4, 1998, hereinafter “Benninga”, wholly incorporated by reference as if set forth herein, describes how to obtain or implement the Value-at-Risk. Conditional Value-at-Risk is another example of the risk measure. Conditional Value-at-Risk refers to an expected loss given that some loss threshold is exceeded. George Ch. Pflug, “Some Remarks on the Value-at-Risk and the Conditional Value-at-Risk”, Cite SeerX, 2003, http://citeseerx.ist.psu.edu/viewdoc/summary?doi=10.1.1.32.8541, hereinafter “Pflug”, wholly incorporated by reference as if set forth herein, describes the Conditional Value-at-Risk in detail.

In addition, the traditional solutions have to use a simple scenario analysis for a small number of combinations representing various realizations of the uncertainties. The scenario analysis refers to a technique of analyzing potential future events by considering alternative possible results (scenarios). A problem with the scenario analysis is that the results obtained by the scenario analysis may not be robust to a full range of the uncertainties inherent in energy (e.g., electricity) markets.

Furthermore, the traditional solutions have no systematic way to quantify the quality or to score the risk-robustness of any given resource plan. Thus, it becomes difficult for a bank or insurance company, for example, to objectively evaluate the quality of any given resource plan submitted by a utility company. More difficult, is a task of evaluating and comparing many resource plans.

Therefore, it is desirable for providing a system, method and computer program product for quantifying the quality and risk-robustness of a given resource plan in terms of standardized risk measures, e.g., Value-at-Risk, Conditional Value-at-Risk, etc.

### SUMMARY

The present invention describes a system, method and computer program product for quantifying the quality and risk-robustness of a given resource plan in terms of standardized risk measures.

In one embodiment, there is provided a computer-implemented method for evaluating a quality and risk-robustness of a utility company's capacity resource plan (CRP), the method comprising:
characterizing a net present value of a total cost distribution of the CRP;
computing a standardized risk measure defined over the net present value; and
computing a resource plan that minimizes the standardized risk measure.

In one embodiment, there is provided a computer-implemented system for evaluating a quality and risk-robustness of a utility company's capacity resource plan (CRP), the system comprising:
a memory device; and
a processor unit in communication with the memory device, the processor unit performs steps of:
   characterizing a net present value of a total cost distribution of the CRP;
   computing a standardized risk measure defined over the net present value; and
   computing a resource plan that minimizes the standardized risk measure.

In a further embodiment, the processor further performs comparing the standardized risk measure and the resource plan to quantitatively assess the quality and risk-robustness of the CRP.

In a further embodiment, the standardized risk measure is one or more of: Value-at-Risk and Conditional Value-at-Risk of the net present value.

In a further embodiment, the resource plan is computed in a stochastic optimization engine.

In a further embodiment, the stochastic optimization engine models uncertainties in fuel cost, an emission limit, technological cost, a performance and abatement option.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 illustrates a system diagram for evaluating the quality and risk-robustness of a utility company's capacity resource plan according to one embodiment.

FIG. 2 illustrates a flow chart including method steps for evaluating the quality and risk-robustness of a utility company's capacity resource plan according to one embodiment.

FIG. 3 illustrates an exemplary net present value in term of a probability distribution according to one exemplary embodiment.

FIG. 4 illustrates an exemplary hardware configuration for implementing the flow chart depicted in FIG. 2 according to one embodiment.

FIG. 5 illustrates an exemplary simulated load forecast according to one embodiment.

FIG. 6 illustrates an exemplary probability distribution showing forward-looking risk in parameters according to one embodiment.

FIG. 7 illustrates that an exemplary probability distribution of a parameter according to one embodiment.

FIG. 8 illustrates an exemplary modeling of a risk of a scenario which describes that a government entity auctions carbon credits according to one embodiment.

### DETAILED DESCRIPTION

A CRP may be associated with a probability distribution of net present value (NPV), where the probability distribution of NPV is a consequence of combining of investment decisions encoded in the CRP along with probabilistic estimates of risks that are present in uncertain quantities (e.g., fuel costs, regulatory regime definition and regulatory parameters, cost and performance of abatement options, etc.). These uncertain quantities may also be modeled as probability distributions. The NPV distribution may then be associated with a risk measure, e.g., a lower 95-percentile value of the NPV distribution. The lower 95-percentile value captures a lower-tail, i.e., the worst-case value of the NPV distribution. Then, a risk-robust CRP may correspond to a value of a risk measure that is within an acceptable tolerance of an optimal, i.e., the best possible value, of the risk measure. The optimal value of the risk measure may also correspond to the best possible CRP plan (i.e. the risk-optimal CRP plan, or CRP plan that is optimal from the perspective of the risk measure). The farther a given CRP plan is from the risk-optimal CRP in terms of a chosen risk measure when applied to corresponding Net Present Value probability distributions, the lower is its quality from a risk-robustness perspective.

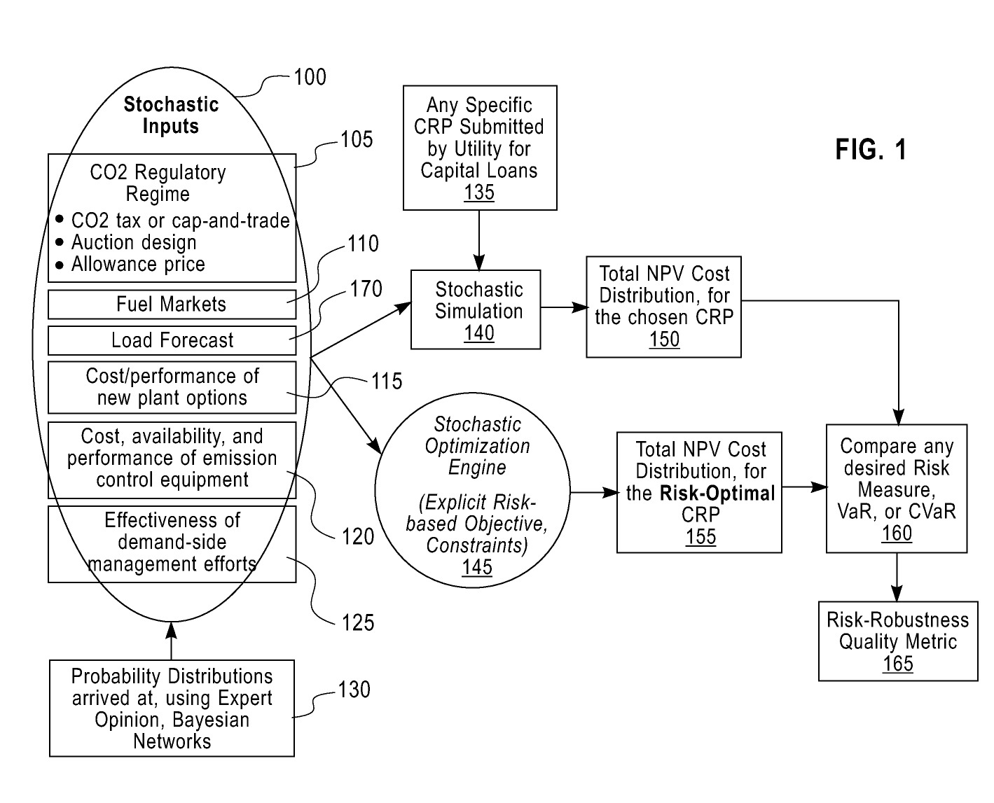

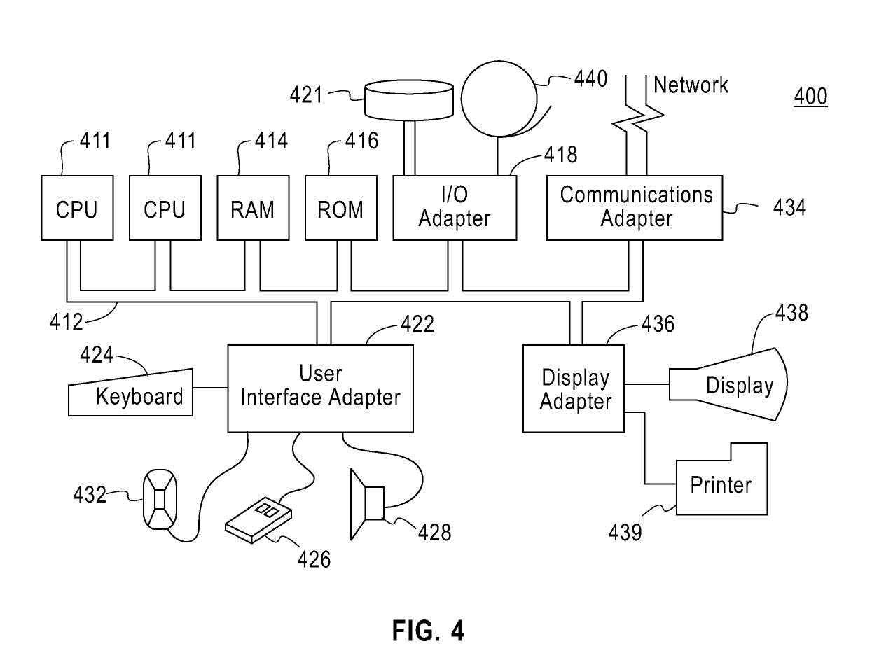

FIG. 1 illustrates a system diagram for evaluating the quality and risk-robustness of a utility company's capacity resource plan according to one embodiment of the present invention. A computing system (e.g., a computing system 400 in FIG. 4) receives stochastic data 100 as inputs. The stochastic data 100 includes, but is not limited to: CO₂ regulatory regimes 105 (e.g., CO₂ fee or cap-and-trade), fuel costs 110, load forecast 170 (e.g., a prediction of a future demand), cost or performance of a new power plant 115, cost, availability and/or performance of emission control equipment 120 (e.g., commercially available Emission Systems from Donaldson Company, Inc., commercially available exhaust scrubbers/air purifiers from Foley Marine & Industrial Engines, Inc.), and effectiveness of demand-side management efforts 125 (e.g., how many customers uses power-saving light bulbs.) The CO₂ cap-and-trade is a possible regulatory requirement whereby a utility company receives a “cap”, i.e. an upper bound, on the amount of CO₂ emissions that it may generate. Any amount of emission that is over and above the “cap” needs to be addressed using a purchase of carbon credits that may be traded with other market participants. The CO₂ fee refers to a payment required from a government regarding CO₂ emission.

In a further embodiment, the computing system obtains the stochastic data 100 in forms of probability distributions, e.g., by using expert opinions and/or Bayesian Networks, etc. A Bayesian Network is a probabilistic graphical representation that depicts a set of random variables and their conditional interdependencies via a directed acyclic graph (DAG). Ben-Gal, “Bayesian Networks” in Encyclopedia of Statistics in Quality and Reliability, John Wiley & Sons, 2007, ISBN 978-0-470-01861-3, wholly incorporated by reference as if set forth herein, describes the Bayesian Network in detail.

Returning to FIG. 1, the computing system runs a stochastic simulation module 140 using the stochastic data 100 and a CRP 135 provided from a utility company. The stochastic simulation module 140 runs stochastic algorithms or methods (e.g., Gillespie algorithm, Markov chain, Monte Carlo method, etc.). Gillespie algorithm produces statistically accurate solutions of a stochastic equation. Gillespie algorithm usually used for simulating reactions within cells or molecules. Gillespie algorithm draws two random numbers at each step, a first random number to determine when a next reaction will occur and a second random number to choose which reaction will occur. Hayot, “Single cell experiments and Gillespie's algorithm”, http://tsb.mssm.edu/summerschool/images/4/4d/HayotSlides.pdf, Aug. 18, 2008, wholly incorporated by reference as if set forth herein, describes Gillespie algorithm in detail. Markov chain is a random process (i.e., unpredictable process) where all information about the future is based on a present state. In Markov chain, a user does not need to evaluate past states to predict the future. Meyn, et al., Chapter 2 “Markov Models” in “Markov Chains and Stochastic Stability”, 2^{nd} Edition, Cambridge University, April 2009, wholly incorporated by reference as if set forth herein, describes Markov chain in detail. Monte Carlo method is a computational algorithm that repeatedly performs random sampling to compute an outcome. Mosegaard, et al., “Monte Carlo sampling of solutions to inverse problems”, Journal of Geophysical Research, Vol. 100, No. B7, page 12,431-12,447, 1995, wholly incorporated by reference as if set forth herein, describes Monte Carlo method in detail.

The stochastic simulation module 140 generates a net present value 150 of a total cost distribution of the CRP 135. In other words, the stochastic simulation module 140 represents the net present value of the CRP in a form of a probability distribution. A net present value (NPV) is a metric to compare a present value of money to a future value of the money. For example, a dollar today may be worth more than a dollar in the future due to potential inflation in the future. The stochastic simulation module 140 computes the NPV, e.g., by calculating Rₜ/(1+i)^{t}, where t is a time of a cash flow, i is a discount rate (i.e., a rate of return that could be earned on an investment in a financial market with a similar risk), and Rₜ is a net cash flow (i.e., an amount of cash at the time of t). Alternatively, a co-pending and co-assigned U.S. patent application, Chowdhary et al., “Developing an optimal long term electricity generation capacity resource plan under a carbon dioxide regulatory regime”, U.S. application Ser. No. 12/690,573, wholly incorporated by reference as if set forth herein, hereinafter “Chowdhary”, also describes a method to calculate the net present value. Chowdhary describes that a minimum net present value is calculated by (capital costs+fuel costs+emission costs). After calculating the net present value of the CRP 135, the stochastic simulation engine 140 computes a standardized risk measure (e.g., Value-at-Risk (VaR), Conditional Value-at-Risk (Conditional VaR), etc.) defined over the net present value. Benninga and/or Pflug, incorporated by references, describe how to compute Value-at-Risk and Conditional Value-at-Risk.

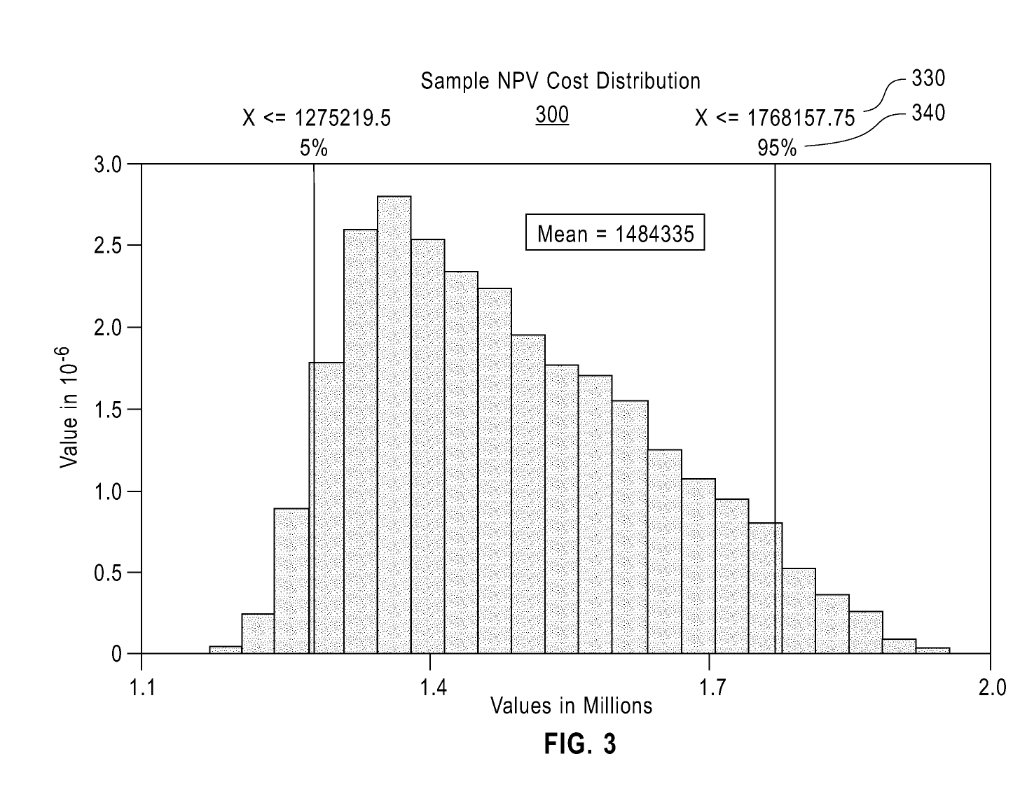

In an exemplary embodiment, the following describes an exemplary method for computing a net present cost probability distribution (i.e., a net present value in a form of a probability distribution; e.g., an exemplary distribution 300 (a sample net present value cost distribution chart) in FIG. 3). First, the computing system computes the distribution, corresponding to a capacity resource plan (CRP), e.g. by using Monte Carlo method. The inputs to Monte Carlo method includes, but are not limited to:
1. A planning horizon (i.e., time period indexed by t=1, 2, . . . , T) that is covered by the CRP
2. A load forecast for each time period, t, along with its probability distribution
3. A set of existing generating assets (e.g., an existing power plant), along with their fuel type, capacity and generation efficiency, and indicator of availability over the planning horizon. The indicator of availability captures a time or moment at which the existing generating assets were procured.
4. A set of new generation assets included in the CRP, along with their fuel type, capacity and generation efficiency, capital costs of their emission abatement, and an indicator of availability over the planning horizon. The indicator of availability captures a time or moment at which a new generation asset is procured.
5. A set of emission abatement investments included in the CRP, along with their abatement effectiveness and capital costs. (Abatement effectiveness refers to how much energy (e.g., fuel) can be saved by a certain investment.)
6. A fuel-price forecast for each time period, t, and each relevant fuel type (e.g., fuel, gas, coal, oil, etc.) along with its probability distribution
7. An emission generation rate for each fuel-type, per unit energy (say kWh) that is generated by existing and/or new generating assets
8. A set of scenarios that capture a timing of an emission regulation, along with a format/structure of regulatory costs/penalties, along with probabilities of the scenarios.

Then, the computing system sets up the stochastic simulation module 140, e.g., by using all or some of the inputs listed above. Each run of the simulation module 140 simulates one possible timeline over the planning horizon. In each possible timeline, random parameters (e.g., uncertainties in fuel costs) in the CRP are sampled to take on specific values. The random parameters that take on specific values in each timeline include, but are not limited to: a simulated load forecast over the planning horizon, a simulated fuel price over the planning horizon for each fuel type, a simulated timing and structure/format of the regulatory costs/penalties.

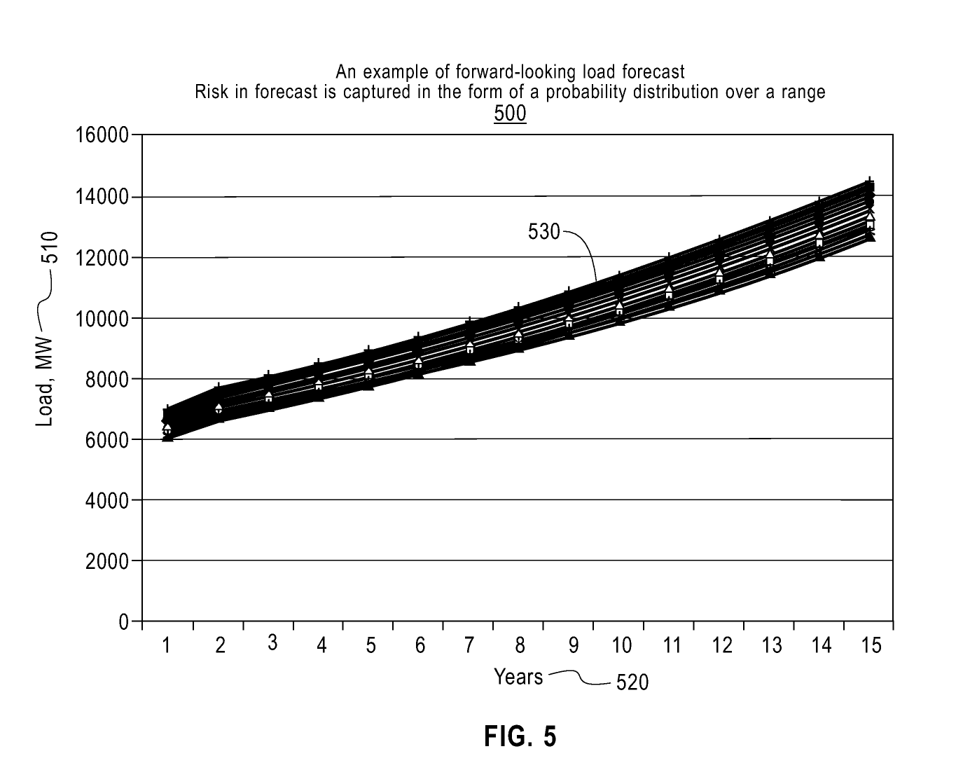

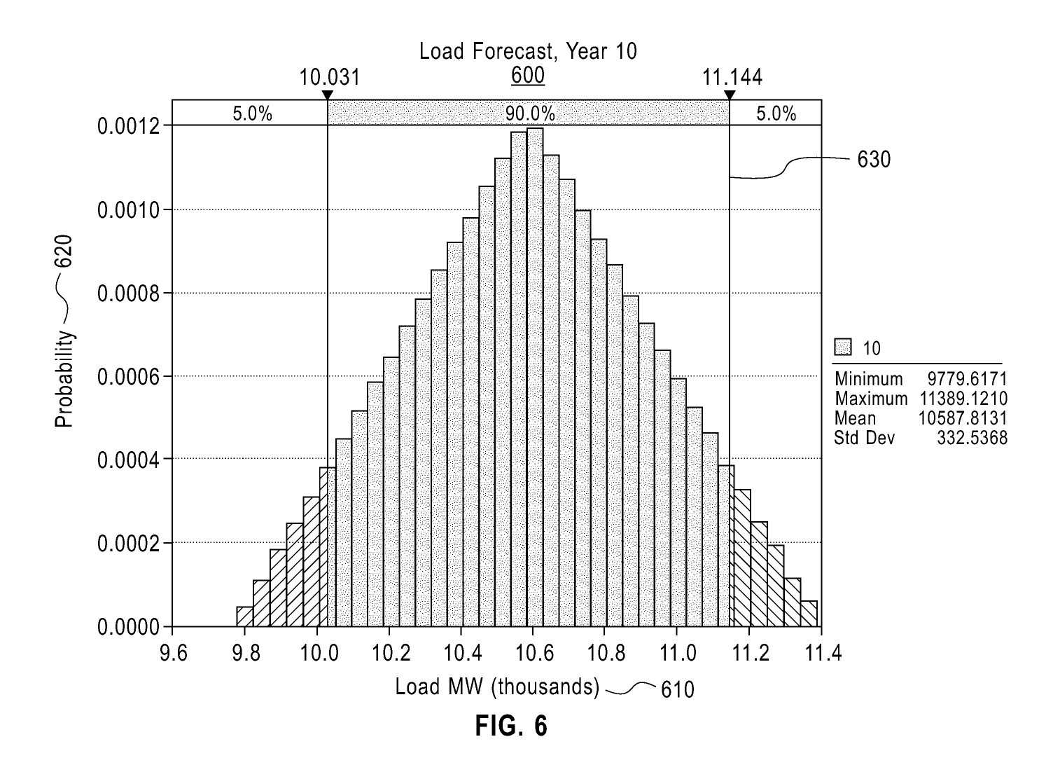

FIG. 5 illustrates an exemplary simulated load forecast 500 over a 15-year horizon 520 over which a Utility company may propose a CRP. The forecast 500 predicts an expected load (Mega Watt) 510 for a given year. A risk in the forecast 500 is captured in a form of a probability distribution. An envelope (e.g., a curve 530) of values corresponding to any given year in the forecast 500 represent a range of values that are expected to be realized with a 95% confidence interval. Specifically, a probability distribution corresponding to any given year, e.g., 10^{th} year is shown in FIG. 6.

FIG. 6 illustrates an exemplary probability distribution 600 showing forward-looking risk (i.e., future risk) in parameters (e.g., fuel prices, abatement efficiency, etc.). Specifically, a box 630 illustrates a probability 620 of an exemplary 10^{th} year load forecast 610. According to this exemplary probability distribution 600, during the 10^{th} year, the Utility company may generate 9779.6171 Mega Watt electricity as a minimum, for example. During the 10^{th} year, the Utility company may generate 11389.1210 Mega Watt electricity as a maximum. The mean (average) electricity generation of the Utility company, during the 10^{th} year, may be 10587.8131 Mega Watt. An exemplary standard deviation of this probability distribution 600 may be 332.5368.

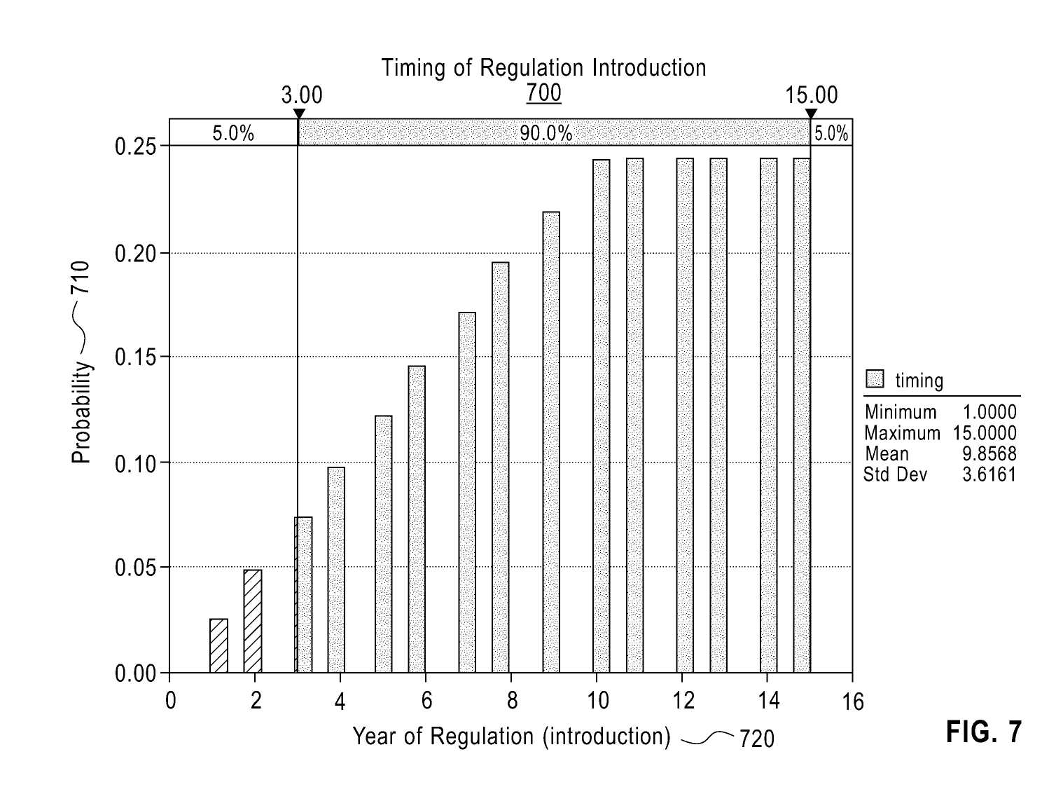

With respect to a risk in a regulatory structure and timing, the risk is as follows: (1) The time at which the regulation is expected to be introduced over the planning horizon is not known with a certainty; (2) These parameters are modeled as probability distributions over the planning horizon. An example of this parameter distribution is shown in FIG. 7 as a discrete probability distribution. FIG. 7 illustrates an exemplary probability distribution 700 of a parameter (e.g., timing of regulation introduction 720). This distribution 700 illustrates a probability 710 of each year in which a government regulation is introduced. This distribution 700 depicts the first year as a minimum timing of regulation introduction and the 15^{th} year as a maximum timing of regulation introduction. The mean (average) value of the distribution 700 is 9.8568. Standard deviation of this distribution 700 is 3.6161.

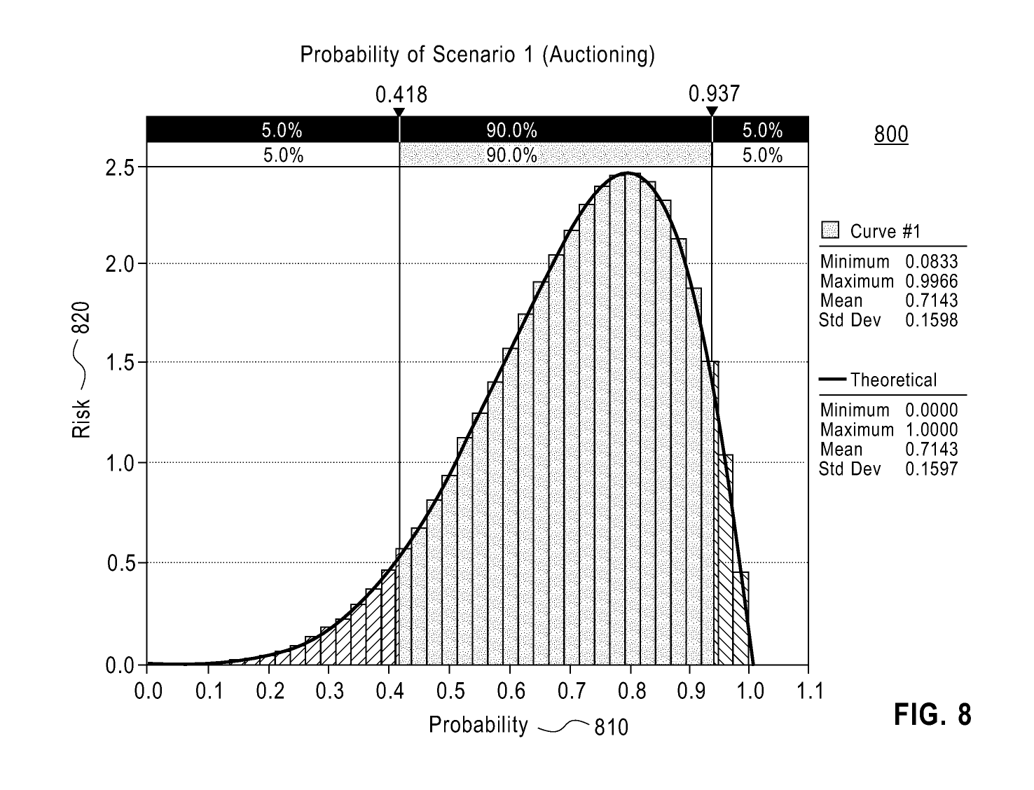

An uncertain parameter may affect the CRP of the Utility company. For example, there is a debate about whether carbon credits may be “auctioned” or “exempted”. In other words, a government entity may choose to auction emissions permits to companies that are required to reduce their carbon emissions. Alternatively, the government can also choose to “exempt” allowances to polluting companies, e.g., by handing them out free credits based on historic or projected emissions. These exemptions may give the most benefits to those polluting companies that have historically done the least to reduce their pollution. The computing system may model the first scenario (“Auctioning”), e.g., as beta-distribution by assigning probabilities to the first scenario, and the second scenario (“Exempting”), e.g., by taking the complementary probability. FIG. 8 illustrates an exemplary modeling a risk of the first scenario. This model 800 corresponds a probability 810 of the first scenario to a risk value 820. Theoretically, the minimum probability of the first scenario is zero. The maximum probability is one. The mean value of the first scenario is 0.7143. The standard deviation of the first scenario is 0.1597. When applying the beta-distribution to the first scenario, the minimum probability of the first scenario becomes 0.0833, the maximum probability of the first scenario becomes 0.9966, the mean value of the first scenario becomes 0.7143 and the standard deviation of the first scenario becomes 0.1598.

Returning to FIG. 1, corresponding to the CRP, the module 140 computes the net present value (NPV) of the total cost distribution, which is incurred by a utility company which prepared the CRP, as a consequence of the CRP and specific realizations of future stochastic (i.e., random) quantities in the simulated timeline. The total cost distribution of the CRP in the simulated timeline includes, but is not limited to:
1. Capital Costs for acquiring new generation assets and emission abatement equipment (e.g., Oxidizers from Anguil Environment Systems, Inc. in Milwaukee, Wis.—an air pollution control product)
2. Operating cost+Fuel cost, that is implied by the generation plan corresponding to the simulated timeline
3. Carbon-related costs, as a consequence of the simulated timing and structure of the regulatory penalty and a net carbon emission that is implied by the generation plan and the CRP.

In order to compute the net present value of the total cost distribution in any simulated timeline, the computing system may establish a generation plan, i.e. a solution in terms of which generation assets are used to satisfy demand, along with their respective set-points that capture an extent of energy generation as a time-profile (i.e., a graph of the energy generation versus time) over the planning horizon. Alternatively, the computing system may use a greedy algorithm to establish the generation plan. The greedy algorithm accepts, as inputs, an available set of generation assets and an increasing sequence of operating costs of the generation assets per unit kWh of the energy generation, subject to a corresponding generation capacity of the generation assets in order to fulfill demand that needs to get satisfied. The greedy algorithm outputs the generation plan. Jeff Erickson, “Non-Lecture A: Greedy Algorithms”, 2006, http://www.cs.uiuc.edu/class/fa06/cs473/lectures/x01-greedy.pdf, wholly incorporated by reference as if set forth herein, describes the greedy algorithm in detail. The generation plan, along with a chosen availability of emission abatement investments in the CRP, then implies a sequence of fuel costs and emission rates or amounts over the planning horizon. The sampled, specific values of the regulation timing and the regulatory cost/penalty structure may then be used to compute carbon-related costs (e.g., costs for filtering carbon emission).

Then, the computing system discounts and/or aggregates various cost contributions to the total cost distribution and thus produces a net present value of the total cost distribution for the CRP in any simulated timeline. For example, collecting or compiling of the net present value of the total cost distribution over multiple timelines (e.g., 10,000 simulated timelines) leads to a histogram or a probability distribution of the net present value of the total cost distribution. The distribution 300 in FIG. 3 illustrates an example of the probability distribution of the net present value of the total cost distribution for an exemplary CRP.

In an alternative exemplary embodiment, to compute the net present value of the total cost distribution within any single simulated timeline, the computing system may use other algorithms. For example, the computing system may apply a deterministic optimization method (e.g., Dijkstra's algorithm, Dynamic Programming, etc.) to find the generation plan that minimizes the total cost distribution, subject to capacity constraints and the CRP. A deterministic optimization method may represent a better performance, i.e., an optimal cost corresponding to the simulated timeline. Dijkstra's algorithm is a graph search algorithm that solves a single source shortest path problem. Dijkstra, “A note on two problem in connexion with graphs”, Numerische Mathematik 1, pages 269-271, 1959, wholly incorporated by reference as if set forth herein, describes Dijkstra's algorithm in detail. The dynamic programming refers to a method for solving a complicated problem by dividing it into simpler problems. By solving these simpler problems, the computing system solves the complicated problem. The dynamic programming is also called divide-and-conquer.

Returning to FIG. 1, the computing system also runs a stochastic optimization engine 145 with the stochastic data 100. The stochastic optimization engine 145 uses optimization models (e.g., a mathematical programming model) which explicitly incorporate the uncertainties in model parameters (e.g. cost, demand, efficiency, etc.) in a form of probability distributions over a corresponding range of possible values. Furthermore, the stochastic optimization engine 145 minimizes the standardized risk measure defined over the generated net present value 150, e.g., by using the mathematical programming model, and outputs this minimized risk measure called an optimal risk measure (or an optimal capacity resource plan) 155. The mathematical programming model finds a set of variables, with particular constraints, that maximizes or minimizes an objective function (e.g., a risk measure). If the objective function and constraints are all linear, the mathematical programming model becomes a linear programming. Green, “Mathematical programming for sample design and allocation problems”, American Statistical Association, Proceedings of the Survey Research Methods Section, 2000, pages 688-692, wholly incorporated by reference as if set forth herein, describes the mathematical programming model in detail.

The computing system 400 compares 160 the standardized risk measure calculated in the stochastic simulation engine 140 and the optimal risk measure 155 calculated in the stochastic optimization engine 145, e.g., by taking a ratio of these two measures (i.e., the standardized risk measure and the optimal risk measure). The closer the ratio is to 1.0, the better the quality and risk-robustness of the CRP 135. Thus, the computing system 400 may use this ratio as a metric indicating the quality and risk-robustness of the CRP 135.

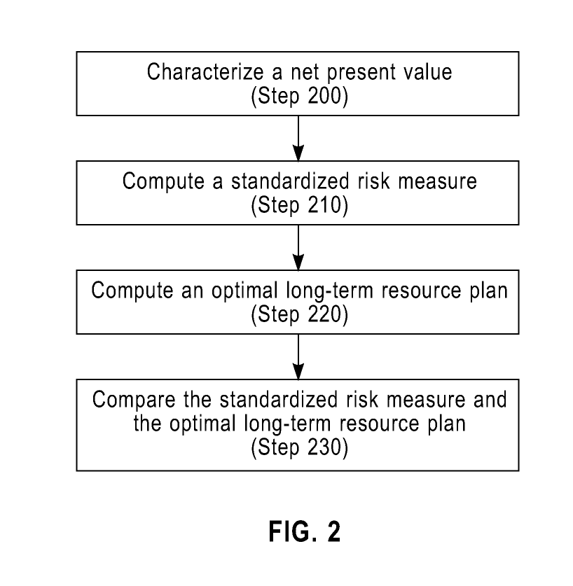

FIG. 2 illustrates a flow chart including method steps for evaluating the quality and risk-robustness of a utility company's capacity resource plan according to one embodiment of the present invention. At step 200, the computing system 400 computes the net present value of a total cost distribution of the CRP 135, e.g., by explicitly modeling uncertainties associated with technology cost or performance described in the CRP 135, regulatory requirements, fuel price and load forecasts, cost of carbon allowance certificates, and capital cost and efficiency of a retrofit option. In one embodiment, the computing system 400 represents the computed net present value in a form of a probability distribution (e.g., the distribution 300 in FIG. 3). The computing system 400 obtains the probability distribution by using any desired technique, e.g., expert opinion, risk elicitation (e.g., a freeware Risk Elicitation 1.0 available at www.sqakki.com/RiskElicitation), Bayesian network, and/or a statistical analysis (e.g., Student's T test—a test assessing whether the means of two groups are statistically different each other). The probability distribution captures a range of various future values in each time period along a corresponding probability density/mass function over the range. FIG. 3 illustrates an exemplary net present value in a form of a probability distribution 300. The total cost distribution includes, without limitation, one or more of: cost of capital investments for a capacity increase and retrofit, fuel cost, carbon related cost (regulatory structure and timing), an emission reduction, a penalty for non-compliance with environmental regulation, cost of carbon allowance certificates, and efficiencies of various capacity increase and retrofit options.

Returning to FIG. 2, at step 210, the computing system 400 computes a standardized risk measure defined over the net present value of the total cost distribution. The standardized risk measure includes, but is not limited to: Value-at-Risk and Conditional Value-at-Risk. The standardized risk measure maps the net present value represented in a form of the probability distribution to a scalar number. For example, in FIG. 3, the net present value probability distribution 300 (i.e., the net present value in a form of a probability distribution) has a mean value of 1484335 and a standard deviation of 153880.2 (not shown). The computing system may derive Value-at-Risk and Conditional Value-at-Risk from the distribution 300 as follows: An upper 95-percentile value (340) is called as the Value-at-Risk (VaR) at the 95-percentile and is essentially the 95% quantile of the distribution 300. In other words, the Value-at-Risk (VaR) at the 95-percentile is a value that will be exceeded only with a 5% probability. This Value-at-Risk (VaR) at the 95-percentile has a value of 1768157.75 (330). The Conditional-value-at-risk (CVaR) at the 95-percentile is a risk measure that captures an average NPV (net present value) cost and is conditional on the NPV cost exceeding its upper 95-percentile value. In other words, the Conditional-value-at-risk (CVaR) at the 95-percentile is the average NPV cost that will be incurred, if the NPV cost were to exceed 1768157.75 (330) in FIG. 3. The CVaR at the 95-percentile in FIG. 3 has a value of 1822109.93 (not shown).

There exist standard techniques for estimating risk measures, e.g., Value-at-Risk (VaR) at 95-percentile and Conditional-Value-at-Risk (CVaR) at 95-percentile. One way to estimate these risk measures is as follows:
Generating an independent sample set of, for example, N=10,000 possible values for the NPV Cost, drawn from the net present value probability distribution. This sample set is inherently available, since the net present value probability distribution is estimated using a simulation (e.g., the stochastic simulation engine 140). So each run of the simulation produces a possible value of the NPV cost. 10,000 runs of the simulation will produce 10,000 values of the NPV cost.
Sorting the 10,000 NPV cost values, e.g., in a descending order, and use the order to estimate VaR and CVaR. The VaR value in this sample set is the 500^{th} largest value (i.e., 95-percentile of the 10,000 NPV cost values) in the sorted descending order. The CVaR value in this sample set is the average of the 500 largest values in the sorted descending order.

Returning to FIG. 2, at step 220, the computing system 400 computes an optimal resource plan (i.e., the optimal risk measure), e.g., by using the stochastic optimization engine 145 to minimize the standardized risk measure defined over the net present value of the total cost distribution. The stochastic optimization engine 145 considers all the uncertainties modeled in step 200 and seeks to minimize the standardized risk measure defined over the net present value of the total cost distribution, e.g., by using a mathematical programming model. The optimal resource plan corresponds to minimizing the standardized risk measure of the net present value of the total cost distribution. The stochastic optimization engine 145 formulates the optimal resource plan over the same set of input parameters (e.g., the stochastic input data 100), which is also applied to the stochastic simulation engine 140. The stochastic optimization engine 145 seeks to optimize the CRP 135 with consideration of a cap-and-trade regulatory requirement. The stochastic optimization engine 145 minimizes a standardized risk measure of the probability distribution that captures the net present value (NPV) of variable and fixed costs over the planning horizon (i.e., a time period associated with the CRP 135) while meeting emission constraints. This minimization is performed over, without limitation, one or more of: at least one viable new capacity (fossil and non-fossil) adjustment, abatement retrofit equipment (e.g., Diesel particulate filters (DPFs)—fine ceramic filters that collect carbon particles) installed at existing power plants, a demand response, a demand or management related abatement choice, and an emission allowance purchase. The computing system 400 performs this minimization in the stochastic optimization engine 145 which models uncertainties in future fuel prices, emission limits, technological cost and performance of abatement options. The computing system 400 computes the optimal resource plan in accordance with a decision planner's risk tolerance (i.e., risk tolerance of a utility company which provided the CRP 135) with respect to fuel cost and energy demand satisfaction. The optimal resource plan establishes a lower bound of the standardized risk measure defined over the net present value of the total cost distribution.

At step 230, the computing system compares the standardized risk measure computed at step 210 with the optimal risk measure (i.e., the optimal resource plan) computed at step 220 to quantitatively assess the quality and/or risk-robustness of the CRP 135. For example, the computing system takes a ratio or a relative error ratio between the standardized risk measure and the optimal risk measure to obtain a quantitative score for the CRP 135. Thus, the computing system defines a metric of the risk-robustness that corresponds to a chosen CRP. The computing system obtains the metric, e.g., by running method steps in FIG. 2.

In a further embodiment, the assessed quality and risk-robustness incorporates risk preferences of financial services firm in terms of a risk measure on an overall, total costs to the utility company, e.g., by achieving a balance in a trade-off between total expected costs and a tail measure (i.e., a number that specifies a mathematical form of an upper end of a probability distribution) of the total cost distribution. The total costs include, without limitation, one or more of: uncertainties in GHG (Green House Gas such as CO₂) regulatory costs, capital and investments costs in capacity increase and advanced metering infrastructure (e.g., a smart meter), and fuel and operational costs. A smart meter refers to an electronic meter that identifies resource (e.g., energy) consumption and communicates information including the identified consumption to a local utility company for monitoring and/or billing purpose. The GHG regulatory costs include, without limitation, GHG fee (e.g., CO₂ fee), Cap-and-trade, GHG allowance auctioning and purchase, and GHG allowance banking.

In one embodiment, there exists variability in demand-growth estimates (i.e., estimating a future increase in customer demand) due to variability in a diffusion and adoption of plug-in hybrid electric vehicles and distributed generation. The plug-in hybrid electric vehicles refer to electric vehicles with batteries that can be recharged an external electric power source. The plug-in hybrid electric vehicles also include gas engines. The distributed generation refers to producing energy from a lot of small energy sources. In one embodiment, there exists variability in demand-growth estimates due to variability in a diffusion and adoption of the smart meters. The demand-growth estimate may be obtained by a customer survey.

The method steps described in FIG. 2 assists banks, financial companies, and/or public regulators to objectively assess the quality and/or risk-robustness of the capacity resource plan that is prepared by a utility company. The method steps in FIG. 2 can also be used to evaluate risks to the utility company from a cost perspective in uncertain future factors (e.g., future fuel costs).

FIG. 4 illustrates an exemplary hardware configuration of a computing system 400 running and/or implementing the method steps in FIG. 2, the stochastic simulation module 145 and/or stochastic optimization engine 145 in FIG. 1. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and run, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to affect one or more functions of this invention. Furthermore, the present invention may be implemented as a program storage device readable by machine, tangibly embodying a program of instructions executable by the machine to perform method steps for causing one or more functions of this invention.

The present invention may be implemented as a computer readable medium (e.g., a memory device, a compact disc, a magnetic disk, a hard disk, an optical disk, solid state drive, digital versatile disc) embodying program computer instructions (e.g., C, C++, Java, Assembly languages, . Net, Binary code) run by a processor (e.g., Intel ® Core ™, PowerPC ®) for causing a computer to perform method steps of this invention. The present invention may include a method of deploying a computer program product including a program of instructions in a computer readable medium for one or more functions of this invention, wherein, when the program of instructions is run by a processor, the compute program product performs the one or more of functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A computer-implemented method for evaluating a quality and risk-robustness of a utility company's capacity resource plan (CRP), the method comprising:
characterizing a net present value of a total cost distribution of the CRP;
computing a standardized risk measure defined over the net present value; and
computing a resource plan that minimizes the standardized risk measure, wherein a processor performs one or more step of: the characterizing, the computing the standardized risk, and the computing the resource plan.

2. The computer-implemented method according to claim 1, wherein the characterizing comprises:
modeling uncertainties associated with one or more of: technology described in the CRP, regulatory requirements, fuel price, cost of carbon allowance certificates, capital cost and efficiency of a retrofit option.

3. The computer-implemented method according to claim 1, wherein the net present value is characterized in a form of a probability distribution.

4. The computer-implemented method according to claim 3, wherein the standardized risk measure is one or more of: Value-at-Risk and Conditional Value-at-Risk of the net present value.

5. The computer-implemented method according to claim 3, wherein the standardized risk measure maps the net present value characterized in the form of the probability distribution to a scalar number.

6. The computer-implemented method according to claim 1, wherein the total cost distribution includes one or more of: cost of capital investments for a capacity increase and retrofit, fuel cost, carbon-related cost, an emission reduction, a penalty for non-compliance with environmental regulation.

7. The computer-implemented method according to claim 1, wherein the resource plan is computed in a stochastic optimization engine.

8. The computer-implemented method according to claim 7, wherein the stochastic optimization engine models uncertainties in fuel cost, an emission limit, technological cost and performance of abatement options.

9. The computer-implemented method according to claim 1, wherein the resource plan is consistent with the utility company's risk tolerance with respect to fuel cost and energy demand satisfaction.

10. The computer-implemented method according to claim 1, wherein the resource plan establishes a lower bound of the standardized risk measure.

11. The computer-implemented method according to claim 1 further comprises:
comparing the standardized risk measure and the resource plan to quantitatively assess the quality and risk-robustness of the CRP.

12. A computer-implemented system for evaluating a quality and risk-robustness of a utility company's capacity resource plan (CRP), the system comprising:
a memory device; and
a processor unit in communication with the memory device, the processor unit performs steps of:
characterizing a net present value of a total cost distribution of the CRP;
computing a standardized risk measure defined over the net present value; and
computing a resource plan that minimizes the standardized risk measure.

13. The computer-implemented system according to claim 12, wherein the characterizing comprises:
modeling uncertainties associated with one or more of: technology described in the CRP, regulatory requirements, fuel price, cost of carbon allowance certificates, capital cost and efficiency of a retrofit option.

14. The computer-implemented system according to claim 12, wherein the net present value is characterized in a form of a probability distribution.

15. The computer-implemented system according to claim 14, wherein the standardized risk measure is one or more of: Value-at-Risk and Conditional Value-at-Risk of the net present value.

16. The computer-implemented system according to claim 14, wherein the standardized risk measure maps the net present value characterized in the form of the probability distribution to a scalar number.

17. The computer-implemented system according to claim 12, wherein the total cost distribution includes one or more of: cost of capital investments for a capacity increase and retrofit, fuel cost, carbon-related cost, an emission reduction, a penalty for non-compliance with environmental regulation.

18. The computer-implemented system according to claim 12, wherein the resource plan is computed in a stochastic optimization engine.

19. The computer-implemented system according to claim 18, wherein the stochastic optimization engine models uncertainties in fuel cost, an emission limit, technological cost and performance of abatement options.

20. The computer-implemented system according to claim 12, wherein the resource plan is consistent with the utility company's risk tolerance with respect to fuel cost and energy demand satisfaction.

21. The computer-implemented system according to claim 12, wherein the resource plan establishes a lower bound of the standardized risk measure.

22. The computer-implemented system according to claim 12, wherein the processor further performs:
comparing the standardized risk measure and the resource plan to quantitatively assess the quality and risk-robustness of the CRP.

23. A computer readable medium embodying computer program instructions being run by a processor for causing a computer to perform method steps for evaluating a quality and risk-robustness of a utility company's capacity resource plan (CRP), said method steps comprising the steps of claim 1.

24. A method of deploying a computer program product including a program of instructions in a computer readable medium for evaluating a quality and risk-robustness of a utility company's capacity resource plan (CRP), wherein, when the program of instructions are run by at least one processor, the computer program product performs the steps of claim 1.
